(19) United States
(12) Patent Application Publication
(10) Pub. No.: US 2016/0012922 A1
(43) Pub. Date: Jan. 14, 2016

(54) Low-contamination, high breeding-yield thorium breeder

(71) Applicant: Yingzhong Lu, Oak Ridge, TN (US)

(72) Inventor: Yingzhong Lu, Oak Ridge, TN (US)

(21) Appl. No.: 14/120,940

(22) Filed: Jul. 14, 2014

(51) Int. Cl. G21C 1/04; G21C 3/02

(52) U.S. Cl. CPC G21C 1/04; G21C 3/02

(57) ABSTRACT

An advanced Th232/U233 thermal breeder with both high specific fuel power and breeding yield is presented. Said breeder is designed as a high specific power, unique hybrid reactor, comprising of a reactor core of solid coated particles of uranium kernel and a separated thorium fluoride liquid annular blanket. The contamination of the first loop is thus greatly reduced. Such a design is based on the existing experience of molten-salt cooling fixed-bed power reactors and HTGR, and, at the same time, eliminates the fatal high contamination resulted from the fission products in traditional liquid fuel thorium breeders. The strong contamination jeopardized the commercialization of the traditional liquid fuel thorium breeders. The high specific power of fuel increases the breeding yield of new fuel. Said low contaminated, high breeding-yield thorium breeder is, therefore, most likely selected as one of the candidates in the Second Nuclear Era.

### BACKGROUND OF THE INVENTION

Plenty thorium resources have been found in the PRC as shown in Table 1 below.

TABLE 1
The comparison of world thorium resource ^{[2]}

| Country | Reasonably Assured Resources, Tons (%) | |
|---|---|---|
| India | 519,000 | (16.62%) |
| Australia | 439,000 | (15.28%) |
| United States | 400,000 | (12.50%) |
| China | 389,000 | (12.19%) |
| Turkey | 344,000 | (10.75%) |
| Venezuela | 302,000 | (9.44%) |
| Brazil | 302,000 | (9.44%) |
| Norway | 132,000 | (4.12%) |
| Egypt | 100,000 | (3.13%) |
| Others | 222,000 | (6.94%) |
| World Total | 3,199,000 | (100%) |

It is estimated that the potential energy contained in its thorium resources, when fully exploited, could even match that provided with the vast coal reserves in this country, and provide all its clean energy demand for thousand of years.

Thorium does not contain fissile material itself. When it absorb neutrons, an artificial fissile element, U-233, is formed. The latter, when irradiated with neutron flux, gives more secondary neutrons (>2.3) is a better nuclear fuel as compared with the natural fissile material U-235, In a thermal breeder comprising of thorium and U-233, more U-233 could be produced than consumed.

The world has been interested in thorium breeders since the earliest time of 1960s. The US ORNL designed, built, and operated the research a 7.4 MWt MSBR through the 1960s; constructed by 1964, it went critical in 1965 and was operated until 1969. A 1000 MWe full-scale MSBR was studied afterward. Holden, Charles S. et al. U.S. Pat. No. 20080144762, disclosed a set of alloy formulations with thorium based nuclear fuels in existing fast and thermal spectrum power reactors; for medical isotope production in the epithermal, the fast, the fission spectrum and the thermal spectra; and to use as fuel in test and experimental reactors.

D'Auvergne, Hector A, U.S. Pat. No. 20100067644, Thorium-based nuclear reactor and method, shows A nuclear reactor and method for generating energy from fertile and fissile nuclear fuel material.

Boubcher, Mustapha, et al. U.S. Pat. No. 20130202076 shows three kinds of fuel bundles for a nuclear reactor, one with thorium, and the others with two different types of fissile fuel.

Kim, Dae-Ho, et al. U.S. Pat. No. 20110299645, shows a breeding nuclear fuel mixture including metallic thorium useable in a nuclear power plant, prepared by mixing uranium dioxide (UO.sub.2) or plutonium dioxide (PuO.sub.2).

It is noted that no big technology break-through in the area of thorium breeder has been addressed in these previous foreign patents. During the past decade, the INET (Institute of Nuclear Energy) in PRC has carried out a series of studies in this area and made substantial progress. The inventor has prepared the following relevant patents to the Chinese Patent Office: (1) Lv, Y, The method to accelerate the breeding of nuclear fuel and the breeders, Chinese Pat. No. ZL200810105349.6, 2008; (2) Lv, Y.A full power, natural circulation, inherently-safe reactor for producing high-temperature nuclear energy, Chinese Pat. No. ZL201010145086.9; and (3) Lv, Y., A comprehensive uranium-thorium converter-breeder and a process for producing U233, Chinese Pat. No. 201310011868.7.

### THE PRESENT INVENTION

An advanced Th232/U233 thermal breeder with both high specific fuel power and breeding yield is presented. Said breeder is designed as a high specific power, unique hybrid reactor, comprising of a reactor core of solid coated particles of uranium kernel and a separated thorium fluoride liquid annular blanket. The contamination of the first loop is thus greatly reduced. Such a design is based on the existing experience of molten-salt cooling fixed-bed power reactors and HTGR, and, at the same time, eliminates the fatal high contamination resulted from the fission products in traditional liquid fuel thorium breeders. The strong contamination jeopardized the commercialization of the traditional liquid fuel thorium breeders. The high specific power of fuel increases the breeding yield of new fuel. Said low contaminated, high breeding-yield thorium breeder is, therefore, most likely selected as one of the candidates in the Second Nuclear Era.

### OBJECTS AND ADVANTAGES OF THE PRESENT INVENTION

Included among the objects and advantages of the invention is to provide an advanced Th232/U233 thermal breeder with both high specific fuel power and breeding yield.

Another object of the invention is to provide a system to reduce the fission product contamination of the fluid thorium fluoride breeding blanket of said breeder.

Yet another object of the invention is to provide a liquid Bi-Li metal extractor to carry the long-half lived Pa-233 to a storage-decay tank outside the breeder.

Still another object of the invention is to provide a fuel preparation chamber to manufacture new fuel elements and fluid thorium fluoride salts for the breeding blanket.

An additional object of the invention is to propose a detailed structure of the low- contamination, high specific fuel power and breeding yield breeder

These and other object and advantages of the invention may be ascertained by the following description and appended drawings.

### GENERAL DESCRIPTION OF THE DRAWINGS

FIG. 1 is a sketch of the complete system of the breeder and associated facilities.

FIG. 2 is a broken away horizontal view of the breeder.

FIG. 3 is a broken away side elevational view of the breeder with the complete integrated primary system.

FIG. 4 is a flow diagram of the breeding system.

### SPECIFIC DESCRIPTION OF THE ILLUSTRATIONS

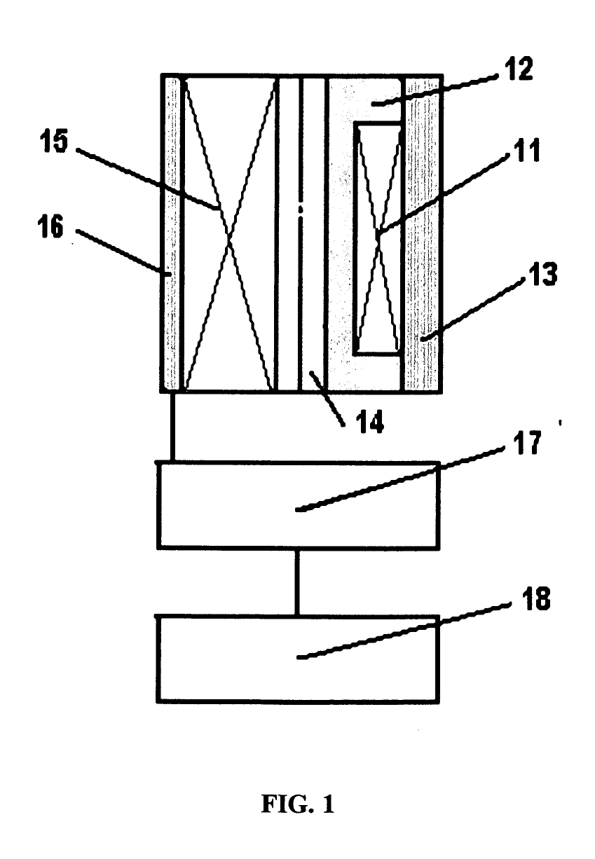

A sketch of the complete system of the breeder and associated facilities is illustrated in FIG. 1.

The two sides of the broken way elevational view of the breeder are taken from different angles of the separate van-shape breeder core and fertile thorium fluoride blanket, respectively. The right-hand view belongs to annular breeder core 11, which comprises of a pebble bed of spherical graphite balls containing coated particles with fissile uranium fuel kernels. Said core is surrounded with graphite reflector 12 on upper, lower and inner sides. The outside is occupied with liquid thorium fluoride blanket 13. A central coolant flow channel 14 is also illustrated.

The left hand elevational view illustrates the fluid thorium fluoride blanket 15, A Bi-Li liquid-metal extractor 16 is located at the outer rim of the breeder section.

The Bi-Li liquid metal with Pa-233 then flows into the storage-decay tank 17. The U-233 produced therein is converted into UF₆ vapor, and finally fabricated into new fuel element in facility 18 for refueling the breeders.

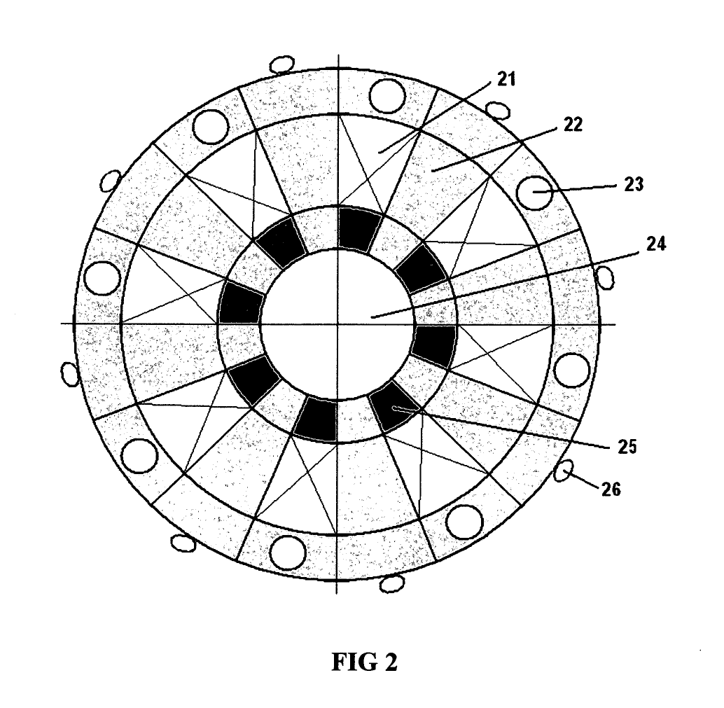

FIG. 2 is a broken away horizontal view of the breeder. It illustrates the details fan-type structure of the breeder section. The van-type uranium fuel pebble-bed 21 is enclosed with the liquid thorium fluoride salts blanket 22 on 3 sides, and a porous graphite bar 25 with a multiplicity of small holes for horizontal flowing molten salt coolant. The Bi-Li extractors 26 are attached to the outer rim of the breeder.

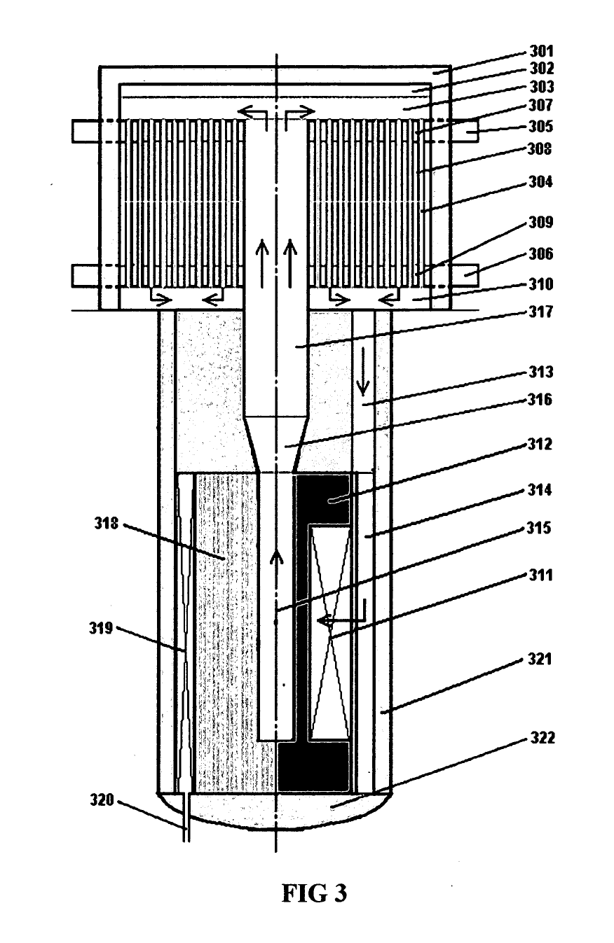

FIG. 3 is a broken away side elevational view of the breeder with the complete integrated primary system. Viewing from top to bottom: the compact primary heat exchangers are installed in a gas-tight cabin 301, wherein an inert gas layer 302 covers the upcoming high-temperature coolant upper plenum 303. The compact heat exchangers are generally deigned as plate-fin type with a multiplicity of vertical narrow flow channels, of which the primary coolant channels are open-ends parallel channels 304 without any deflector section at both ends. The primary coolant could, therefore, flow through these channels with minimum resistance. On the contrary, the secondary coolant, coming via the inlet pipe 305 and leaving via outlet pipe 306, has to enter the top deflector section 307, flowing downward via vertical parallel channels 308, and eventually leaves via the bottom deflector section 309 before entering the outlet pipe.

After the cooled primary coolant enters the lower plenum 310, the coolant down-flow alone the down-comer channels 313 into a annular plenum 314, wherein it eventually turns inward, passing through the pebble-bed breeder core 311. The coolant is heated in the pebble-bed with fission energy. Then it is collected and flows upward alone the central high-temperature coolant pipe 315. The up-flowing coolant then enters a diffuser 316, and flows upward alone the riser 317. The high-temperature coolant is pushed upward with the buoyancy force created by the density difference between low-temperature and high-temperature coolants. Natural circulation of the entire primary system is thus realized.

The left half of the elevational view of the breeder is taken through the fertile thorium fluoride blanket section 318. The attached Bi-Li extractor is illustrated as 319. A pipeline 320 connecting the extractor to the outside Pa233 storage-decay tank is also illustrated.

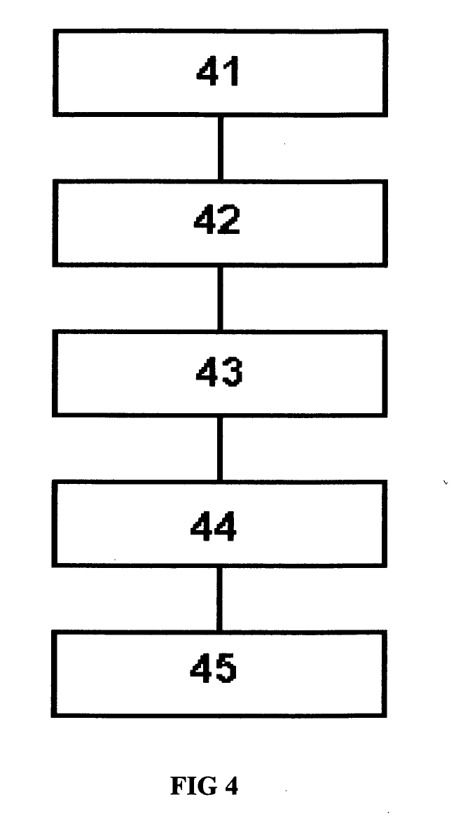

FIG. 4 is a flow diagram of the breeding system. The five steps of the process are illustrated: Step 41—in the reactor core, comprising of U233 fuel, produces extra neutrons for breeding purpose;
Step 42—in the thorium fluoride blanket, absorbing the extra neutrons to produce Pa233;
Step 43—in the Bi-Li extractor, extracting Pa233, send the latter into Pa233 storage-decay tank;
Step 44—in the storage-decay tank, producing U233F6, send the latter to fuel fabrication facility;
Step 45—in the fuel fabrication facility, producing new fuel elements and fertile thorium salts, send the latter to breeder for refueling and to feed new breeders.

What is claiming is:

1. A low-contamination, high breeding-yield thorium breeder, comprising a multiplicity of breeding units with alternative fan-type fissile fuel core and fertile thorium salt blanket; wherein:
The fissile fuel core comprises of spherical graphite fuel element containing a multiplicity of coated particles with kernels containing fissile fuel U233;
The fissile fuel core is enclosed with a first layer of graphite reflector, a second layer of fertile thorium salt blanket;
The center of said core has a high-temperature coolant flow channel;
The outer rim of said fertile thorium salt blanket has a Bi-Li extractor to extract Pa233 from thorium salts;
The said extractor is connected to an outer storage-decay tank for the formation of U233 from Pa233;
The said U233 is combined with fluorine to form UF₆ and the latter is sent to a fuel fabrication facility to produce new fuel elements.

2. The low-contamination, high breeding-yield thorium breeder of claim 1, wherein the said spherical graphite fuel element is operated under a specific power equal or higher than 3 MWt/kgU233.

3. The low-contamination, high breeding-yield thorium breeder of claim 1, wherein the heat generated in the fertile thorium salt blanket is dissipated from the outer storage-decay tank.

4. The low-contamination, high breeding-yield thorium breeder of claim 1, wherein said spherical graphite fuel element containing a multiplicity of coated particles with kernels containing natural uranium enriched with U235 and operating as a U235 to U233 converter.

5. A low-contamination, high breeding-yield thorium breeding process, comprising the following steps:
Step1. In the reactor core, comprising of U233 as fissile fuel, produces extra neutrons for breeding purpose;
Step2. In the thorium fluoride blanket, absorbing the extra neutrons to produce Pa233;
Step3. In the Bi-Li extractor, extracting Pa233, send the latter into Pa233 storage-decay tank;
Step4. In the storage-decay tank, producing U233F6, send the latter to fuel fabrication facility;
Step5. In the fuel fabrication facility, producing new fuel elements and fertile thorium salts, send the latter breeder for refueling and to feed new breeders.

6. The low-contamination, high breeding-yield thorium breeding process of claim 4, wherein the U233 as fissile fuel is in the form of spherical graphite ball containing a multiplicity of coated particles with U233 kernels.

7. The low-contamination, high breeding-yield thorium breeding process of claim 5, wherein the spherical graphite ball is operated under a specific power equal or higher than 3 MWt/kgU233.

8. The low-contamination, high breeding-yield thorium breeding process of claim 4, wherein the heat generated in the fertile thorium salt blanket is dissipated from the outer storage-decay tank.
